(19) United States
(12) Patent Application Publication
(10) Pub. No.: US 2023/0100967 A1
(43) Pub. Date: Mar. 30, 2023

(54) Membrane Stacks and Their Uses

(71) Applicants: Fujifilm Manufacturing Europe B.V., Tilburg (NL); Fujifilm Corporation, Tokyo (JP)

(72) Inventors: Adrianus Jacobus Van Rijen, Tilburg (NL); Elisa Huerta Martinez, Tilburg (NL)

(21) Appl. No.: 17/904,999

(22) PCT Filed: Apr. 1, 2021
(86) PCT No.: PCT/EP2021/058646

§ 371 Date: Aug. 25, 2022

(30) Foreign Application Priority Data
Apr. 2, 2020 (GB) 2004897.1
Apr. 2, 2020 (GB) 2004899.7
Sep. 23, 2020 (GB) 2015030.6
Dec. 7, 2020 (GB) 2019229.0

(51) Int. Cl. B01D 61/50; B01J 47/12; B01J 39/04; B01J 39/18; B01J 41/04; B01J 41/12; C02F 1/469; C12H 1/04; A23C 9/144; A23L 2/78; B01D 53/26; B01D 61/46; B01D 69/02

(52) U.S. Cl. CPC B01D 61/50; B01J 47/12; B01J 39/04; B01J 39/18; B01J 41/04; B01J 41/12; C02F 1/4693; C12H 1/0432; A23C 9/144; A23L 2/78; B01D 53/26; B01D 61/463; B01D 69/02; A23V 2002/00; B01D 2325/42; B01D 2325/43

(57) ABSTRACT

A stack of ion exchange membranes suitable for water purification comprising a plurality of anion exchange membranes (AEMs) and a plurality of cation exchange membranes (CEMs), wherein the colour properties of the AEMs are visibly different to the colour properties of the CEMs. The invention also provides a process for making membrane stacks in which the likelihood of there being two consecutive membranes of like charge is reduced. Furthermore, it is easy to identify whether there are two consecutive membranes of like charge present in the stacks.

This invention relates to membrane stacks and to their preparation and use.

An increasing world population, decreasing water supply and droughts are leading to increased demand for fresh water. A process known as electrodialysis (“ED”) has been used to convert brackish water into potable water. This process is particularly useful in coastal areas having a plentiful supply of brackish water. The first commercially available ED units were developed in the 1950's. Since then, improvements in ion exchange membranes have led to significant advances in ED.

ED units typically comprise one or more membrane stacks. Each stack comprises an anode, a cathode and a number of cell pairs through which fluids pass. A cell pair typically comprises an ion diluting compartment and an ion concentrating compartment. Each cell comprises a wall made from a negatively-charged cation exchange membrane (a cation exchange membrane or “CEM”) and a wall made from a positively-charged anion exchange membrane (an anion exchange membrane or “AEM”). When a feed fluid passes through the ion diluting compartment and a DC voltage is applied across the electrodes, dissolved cations pass through the CEM and towards the cathode, whereas dissolved anions pass through the AEM and towards the anode, in each case into an ion concentrating compartment. Typically the cathode and anode are washed with a rinse fluid during the deionisation process. In this way, the cations and anions (e.g. Ca²⁺, Na⁺, SO₄²⁻ and Cl⁻) originally present in the feed fluid permeate through the membranes walls, to leave behind a stream of desalinated water (having a lower ionic content than the original feed fluid) and streams of water containing elevated levels of ions are created. ED units are useful for converting a feed fluid of brackish water into potable water having a much lower content of dissolved salts.

In view of the membrane stacks used in ED units comprising alternate AEMs and CEMs, it is important to ensure that AEMs and CEMs are in the right order. However, hitherto the AEMs and CEMs used to make ED units are visually indistinguishable. Consequently, errors occur during manufacture of ED units in which two membranes of like charge are included consecutively (e.g. AEM then AEM or CEM then CEM, instead of AEM then CEM). Furthermore, it is very difficult to tell when viewing an ED stack whether the AEMs and CEMs alternate, as is desired, or whether two membranes of like charge are included consecutively to give a defective ED unit.

In view of the foregoing, it is an object of the present invention to provide a process for making membrane stacks in which the likelihood of there being two consecutive membranes of like charge is reduced. Furthermore, it is an object of the present invention to provide membrane stacks in which it is easier to identify whether there are two consecutive membranes of like charge present.

According to a first aspect of the present invention there is provided a stack of ion exchange membranes comprising a plurality of anion exchange membranes (AEMs) and a plurality of cation exchange membranes (CEMs), wherein the colour properties of the AEMs are visibly different to the colour properties of the CEMs.

In this document (including its claims), the verb “comprise” and its conjugations is used in its non-limiting sense to mean that items following the word are included, but items not specifically mentioned are not excluded. In addition, reference to an element by the indefinite article “a” or “an” does not exclude the possibility that more than one of the elements is present, unless the context clearly requires that there be one and only one of the elements. The indefinite article “a” or “an” thus usually mean “at least one”.

The stack preferably comprises at least 10 CEMs and at least 10 AEMs, more preferably at least 25 CEMs and at least 25 AEMs.

The visible difference in colour properties between the AEMs and CEMs in membrane stacks make the membranes distinguishable by human eye and by automatic sensors or similar recognition systems. For human operation the visible difference in colour properties between the AEMs and CEMs is preferably visible when the AEMs and CEMs are viewed in, for example, daylight and/or in artificial light (e.g. light produced by electrical means, e.g. light used in an industrial environment. For automated manufacture of membrane stacks the visible difference in colour properties between the AEMs and CEMs is preferably visible in daylight and/or in artificial light. Artificial light is typically produced by electrical means and includes, for example, visible light (e.g. white, red, orange, yellow, green, blue, indigo and violet light), ultraviolet light and infrared light.

In one preferred embodiment, the visible difference in colour properties between the AEMs and CEMs is preferably visible under yellow light, especially artificial yellow light (e.g. light of wavelength above 490 nm) as this is particularly useful for making membrane stacks industrially from AEMs and/or CEMs which are sensitive to (e.g. degrade in) blue light.

The colour properties of the CEMs and AEMs and the visible differences therebetween may be quantified spectrophotometrically, e.g. using a spectrophotometer, for example a Konica Minolta CM-3600d spectrophotometer, e.g. using an 8 mm MAV measurement area.

Suitable parameters to quantify the colour properties of the CEMs and AEMs and the visible differences therebetween are derived from CIEDE2000. CIEDE2000, an International standard specified by the International Commission on Illumination, expresses colour properties and differences using e.g. the CIE L*a*b* colour space or CIELCh colour space where instead of Cartesian coordinates a*, b*, the cylindrical coordinates C′ (chroma, relative saturation) and h′ (hue angle) are specified. The lightness L is the same for both colour spaces.

The three coordinates of CIE L*a*b* represent the lightness of the colour (L*=0 yields black and L*=100 indicates diffuse white, specular white may be higher), its position between red/magenta and green (a*, negative values indicate green while positive values indicate magenta) and its position between yellow and blue (b*, negative values indicate blue and positive values indicate yellow).

It is the aim of this invention to provide stacks comprising AEMs and CEMs wherein the colour properties of the CEM are visibly different to the colour properties of the AEM, preferably by including a dye in the AEMs and/or the CEMs. However, excessive amounts of dye are undesirable since this would increase manufacturing costs.

For an easily visible difference in colour properties between the AEMs and the CEMs the colour of the AEMs and/or the CEMs is preferably not too white. Therefore preferably the AEMs and/or CEMs have a lightness L′ lower than 90, more preferably lower than 80, especially lower than 70 (e.g. lower than 60).

On the other hand, the colour of the AEMs and/or the CEMs should not be too dark. Therefore preferably the AEMs and/or CEMs have a lightness L′ higher than 5, more preferably higher than 8, especially higher than 10, more especially at least 15, e.g. at least 20.

The relative saturation chroma C′ of the AEMs and/or CEMs (which can be regarded as the normalized average of a* and b*) is preferably at least 4, more preferably at least 5 and especially at least 8.

The hue h′ of the AEMs and/or CEMs (as expressed by h′ according to CIEDE2000) is preferably less than 70° or at least 100°, more preferably, less than 60° or at least 120°. This preference arises because hue values between 70° and 100° are yellowish which colour is not easily visible under standard indoor lighting conditions, especially under yellow light conditions. In a specific embodiment, the hue is preferably less than 100° or at least 210° (because greenish colours are less preferred).

A difference in colour is preferably expressed as ΔE₀₀ being the well-known formula of CIEDE2000 also referred to as CIELab 2000. Details can be found in e.g. Luo M. R. (2016) CIEDE2000, History, Use, and Performance. In: Luo M. R. (eds) Encyclopedia of Colour Science and Technology. Springer, New York, N.Y. https://doi.org/10.1007/978-1-4419-8071-7_7 and in the ISO standard ISO 11664-6:2014.

The colour difference ΔE₀₀ between the AEMs and the CEMs is preferably at least 4, more preferably at least 8, especially at least 15. Generally ΔE₀₀ is less than 95, especially less than 90.

In the case that the difference in lightness between the AEMs and the CEMs (ΔL′) and the difference in chroma between the AEMs and the CEMs (ΔC′) are very low, a visible difference in colour properties may still be present. This can be characterized by Δh′>20 degrees, preferably Δh′>50 degrees.

Preferably the colour properties of the AEMs and/or the CEMs are substantially homogeneous, i.e. the colour difference ΔE₀₀ between different parts of the AEMs is preferably less than 5 and/or the colour difference ΔE₀₀ between different parts of the CEMs is preferably less than 5.

In a preferred embodiment, for easy determination of which membrane is the CEM and which is the AEM, one or both of the AEMs and CEMs comprises a dye or a combination of dyes such that the colour properties of the CEMs are visibly different to the colour properties of the AEMs, e.g. the AEMs and the CEMs may contain different dyes or different combinations of dyes, contain the same dye or combination of dyes but in different amounts and/or different ratios.

Preferably the AEMs and/or CEMs contain a dye. Optionally both the AEMs and the CEMs contain a dye. In one embodiment the AEMs and the CEMs each contain a different dye. In another embodiment the AEMs and the CEMs contain the same dye but in different amounts.

For economic reasons it is preferred that the CEMs and/or AEMs comprise a dye which has another function in addition to providing visible colour. In a preferred embodiment the CEMs and/or AEMs comprises a dye which is a photoinitiator. The dye is preferably capable of generating a radical upon interaction with a co-initiator when in the excited state: upon interaction with the dye, the co-initiator forms a radical species. Thus the dye(s) present in the CEMs and/or AEMs are preferably dyes which do not form ions when irradiated with light. In other words, preferably the AEMs and CEMs are free from dyes which form ions when irradiated with light. It is especially preferred that the dye(s) present in the CEMs and/or AEMs are dyes that cannot undergo a regenerative and reversible light-driven dissociation or light-driven association reaction to generate a positively-charged ion and a negatively-charged ion.

Preferably the dye(s) which may be present in the CEMs and/or AEMs do not pose a health risk, e.g. the dye(s) are preferably free from transition metal ions. Examples of transition metals include Cr, Co, Cu, Ir, Mn, Ni, Os, Ru, Pd, Pt and Re.

Preferably the dye is not, at least initially, covalently bound to the AEMs and/or CEMs. For example the dye may be physically entrapped within the CEMs or AEMs. This enables more flexibility in the selection of dyes, including cheaper dyes, and easier manufacturing of the stacks.

The use of a dye which is also a photoinitiator (instead of using a separate dye and uncoloured photoinitiator) leads to cost advantages by eliminating the need for a separate dye in order to obtain a CEMs having visibly different colour properties to the AEMs or an AEMs having visibly different colour properties to the CEMs. Thus the dye is preferably a coloured photoinitiator.

In some cases the chemical structure of the dye changes after irradiation. After irradiation the dye may form reaction products which have a different colour from the dye before irradiation or the dye may lose its colour. The latter is not preferred although unreacted dye may remain and hence provide a colour to the formed AEMs or CEMs.

In one embodiment the AEMs and/or CEMs are formed from irradiating a curable composition which comprises excess dye which is a photoinitiator (i.e. ‘coloured photoinitiator’). As a result there will be some unreacted coloured photoinitiator remaining in the AEMs and/or CEMs after the irradiation and thus the CEMs and AEMs will have a colour corresponding to the colour of unreacted coloured photoinitiator used to form it.

When both the AEMs and the CEMs are formed by photo curing and both require a photoinitiator then preferably the curable compositions used to form the AEMs and CEMs comprise different amounts of the same coloured photoinitiator and/or different coloured photoinitiators. However, due to differences in charge and structure between the monomers in the curable composition used for preparing the AEMs and the monomers in the curable composition used for preparing the CEMs surprisingly in some cases the AEMs and the CEMs end up having visibly different colour properties even when the same coloured photoinitiator is used in each curable composition in the same amount or concentration. This allows for a more efficient manufacturing process since it is possible to use the same dye as coloured photoinitiator for both the CEMs and the AEMs and still achieve CEMs having visibly different colour properties to the AEM.

Preferably the CEMs and/or the AEMs comprise (e.g. as component (b) in the above curable composition) a dye having an absorption maximum at a wavelength longer than 400 nm, more preferably longer than 400 nm and up to 800 nm, especially between 430 nm and 800 nm, when measured in one or more of the following solvents at a temperature of 23° C.: water, ethanol and toluene.

The absorption maxima are preferably measured using a 0.01 wt % concentration of the dye (e.g. a coloured photoinitiator) dissolved in the relevant solvent (i.e. water, ethanol or toluene) at 23° C., e.g. using a 1 mm path length (e.g. a quartz cuvette having an internal length through which light passes of 1 mm). One may measure the absorption maximum using, for example, a Varian Cary™ 100 conc. double beam UV/VIS spectrophotometer from Agilent Technologies.

The molar attenuation coefficient at the absorption maximum (i.e. longer than 400 nm) of the dye is preferably at least 7,500 M⁻¹ cm⁻¹ (750 m² mol⁻¹), more preferably at least 10,000 M⁻¹ cm⁻¹. The molar attenuation coefficient may be measured using an UV-VIS spectrophotometer, e.g. a Cary™ 100 UV-visible spectrophotometer from Agilent Technologies.

Preferably the dye is a xanthene, flavin, curcumin, porphyrin, anthraquinone, phenoxazine, camphorquinone, phenazine, acridine, phenothiazine, xanthone, thioxanthone, thioxanthene, acridone, flavone, coumarin, fluorenone, quinoline, quinolone, naphtaquinone, quinolinone, arylmethane, azo, benzophenone, carotenoid, cyanine, phtalocyanine, dipyrrin, squarine, stilbene, styryl, triazine or anthocyanin-derived photoinitiator, in each case provided that it has an absorption maximum at a wavelength longer than 400 nm, when measured in one or more of the following solvents at a temperature of 23° C.: water, ethanol and toluene, or a mixture comprising two or more thereof (e.g. from 2 to 5 of such photoinitiators).

Examples of dyes that can function as photoinitiator having the absorption maximum specified above include eosin Y, eosin Y disodium salt, fluorescein, uranine, erythrosine B, rose bengal, phloxine B, 4,5-dibromofluorescein, rhodamine B, riboflavin, flavin mononucleotide, acriflavin, curcumin, resazurin, safranin O, phenosafranin, neutral red, acridine orange, acid blue 43, 1,4-diamino-anthraquinone, 1,4-dihydroxy-anthraquinone, bromaminic acid sodium salt, carminic acid, ethyl violet, patent blue V, methyl orange, naphtol yellow S, methylene blue, indigo carmine, (4-dimethylaminostyryl)methylpyridinium iodide, quinoline yellow, quinoline yellow WS, thionine acetate, beta-carotene, coumarin 6, coumarin 343, coumarin 153, zinc-protoporphyrin IX, zinc-tetraphenylporphyrin tetrasulfonic acid, zinc-phtalocyanine, cyanidin chloride, indomonocarbocyanine sodium, resorufin, nile red, pyronin Y, 9-fluorenone carboxylic acid, 3-butoxy-5,7-diiodo-6-fluorone, 3-hydroxy-2,4,5,7-tetraiodo-6-fluorone, 2-chlorothioxanthone and quercetin. Preferred dyes include safranin-O, acridine orange, bromaminic acid sodium salt, ethyl violet, methyl orange, curcumin, riboflavin, flavin mononucleotide, methylene blue, zinc phthalocyanine, tetraphenylsulfonate porphyrin, quinolone yellow WS, quinaldine red, eosin Y, eosin Y disodium salt, erythrosin B, rose bengal, rhodamine B, phloxine B and dibromofluorescein.

The dye preferably comprises a conjugated system having at least 10 (more preferably at least 12) delocalized ( [symbol] ) electrons. A conjugated system is a system of connected p-orbitals with delocalized electrons in molecules, generally having alternating single and multiple bonds.

For stacks intended for use in water purification, food or pharmaceutical applications the dye(s) is or are preferably known to be harmless and/or are approved for food and/or pharmaceutical use (e.g. by the U.S. Food and Drug Administration (FDA)), e.g. erythrosin B, flavin mononucleotide, curcumin, riboflavin, tartrazine, quinolone yellow, azorubine, amaranth, ponceau 4R, allura red AC, patent blue V, indigo carmine, brilliant blue FCF, chlorophyll derivatives, copper complexes of chlorophyll or chlorophyllin derivatives, carotenoids, sunset yellow FCF, carminic acid, green S, xantophyll derivatives, brilliant black BN, or one or more thereof.

The dye typically absorbs light at a wavelength longer than 400 nm to generate an excited photoinitiator molecule which abstracts an electron, a proton or both from a co-initiator to generate a free radical. Thus the curable composition preferably comprises a co-initiator. The free radical then causes curable monomers to cure. The co-initiator may be any chemical which can generate a free radical in reaction with the dye when the latter is in an electronic exited state, e.g. when the curable composition is irradiated with light matching with the absorption spectrum of the dye.

As the dye has a colour which is visible to the human eye, the resulting membranes (i.e. AEMs and CEMs) are coloured: e.g. they absorb light in the wavelength range between 400 and 800 nm. By using a different dye for each membrane type (e.g. different membrane types such as anion exchange membrane, cation exchange membrane, monovalent anion exchange membrane, monovalent cation exchange membrane etc.), or the same dye in different amounts, each membrane type can be provided with a unique colour or depth of shade, thereby making it easier to assemble the stack of membranes according to the first aspect of the present invention and reducing the chances of making a stack in which the ion exchange membranes are in the wrong order.

Preferably the AEMs and/or the CEMs are obtainable by irradiating a curable composition comprising a dye which functions as a photoinitiator with light. Preferably the curable compositions comprise:

(a) one or more curable monomers comprising at least one anionic group (to give a CEM) or cationic group (to give an AEM);
(b) a dye;
(c) optionally a co-initiator;
(d) optionally a curable monomer which is free from anionic and cationic groups; and
(e) optionally a solvent.

The curable composition preferably comprises a curable monomer comprising at least one anionic group or cationic group (component (a)), i.e. a cationic group for the AEMs and an anionic group for the CEMs. The preferred anionic group(s) which may be present in the curable monomer include acidic groups, for example a sulpho, carboxy and/or phosphato groups, especially sulpho groups. Preferred cationic group(s) which may be present in the curable monomer include quaternary ammonium and phosphonium groups, especially quaternary ammonium groups.

Preferably the curable monomer is not polymeric, but monomeric or oligomeric, i.e. the curable monomer preferably has a molecular weight (MW) which satisfies the equation:

MW<(3000+300n)

wherein:

MW is the molecular weight of the curable monomer; and

n has a value of 1 to 6 and is the number of ionic groups present in the curable monomer.

The curable monomer preferably comprises an anionic group or a cationic group and one or more ethylenically unsaturated groups, e.g. polymerizable ethylenically unsaturated groups.

Depending on the pH of the curable composition, the anionic or cationic groups present in the curable monomer may partially or wholly form a salt with a counter-ion, e.g. sodium, lithium, ammonium, potassium and/or pyridinium for anionic groups and chloride and/or bromide for cationic groups.

The preferred ethylenically unsaturated groups which may be present in the curable monomer are vinyl groups, e.g. in the form of (meth)acrylic, allylic or styrenic groups. The (meth)acrylic groups are preferably (meth)acrylate or (meth)acrylamide groups, more preferably (meth)acrylamide groups, e.g. acrylamide or methacrylamide groups.

Due to environmental and health considerations, the use of a perfluorinated polymer backbone, such as poly(tetrafluoroethylene), is not preferred. Generally non-perfluorinated monomers are lower in cost. Therefore perfluorinated monomers are not preferred and hence the stack is preferably free from perfluorinated polymers.

Examples of preferred curable monomers include the following compounds of Formula (A), (B), (CL), (SM), (MA), (MB-α), (C), (ACL-A), (ACL-B), (ACL-C), and/or (AM-B):

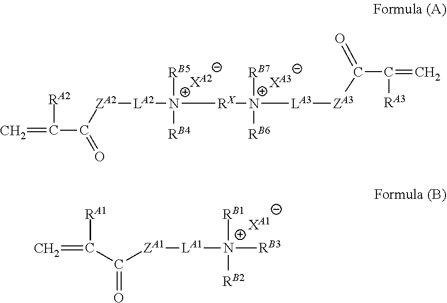

wherein in Formulas (A) and (B),
R^{A1} to R^{A3} each independently represent a hydrogen atom or an alkyl group;
R^{B1} to R^{B7} each independently represent an alkyl group or an aryl group;
Z^{A1} to Z^{A3} each independently represent —O— or —NRa—, wherein Ra represents a hydrogen atom or an alkyl group;
L^{A1} to L^{A3} each independently represent an alkylene group, an arylene group or a divalent linking group of a combination thereof;
R^{X} represents an alkylene group, an alkenylene group, an alkynylene group, an arylene group, or a divalent linking group of a combination thereof; and
X^{A1} to X^{A3} each independently represent an organic or inorganic anion, preferably a halogen ion or an aliphatic or aromatic carboxylic acid ion.
Examples of compounds of Formula (A) or (B) include:

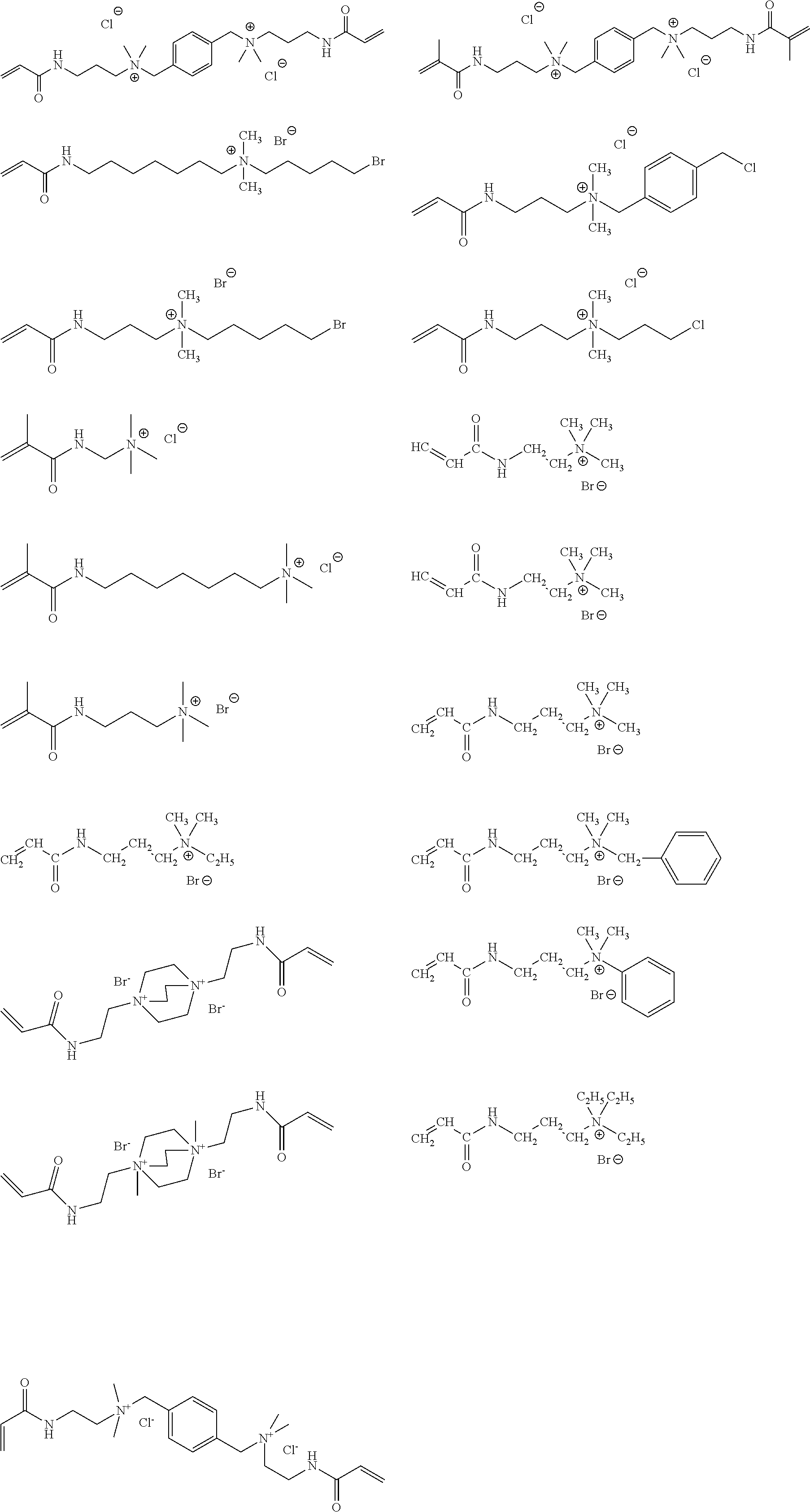

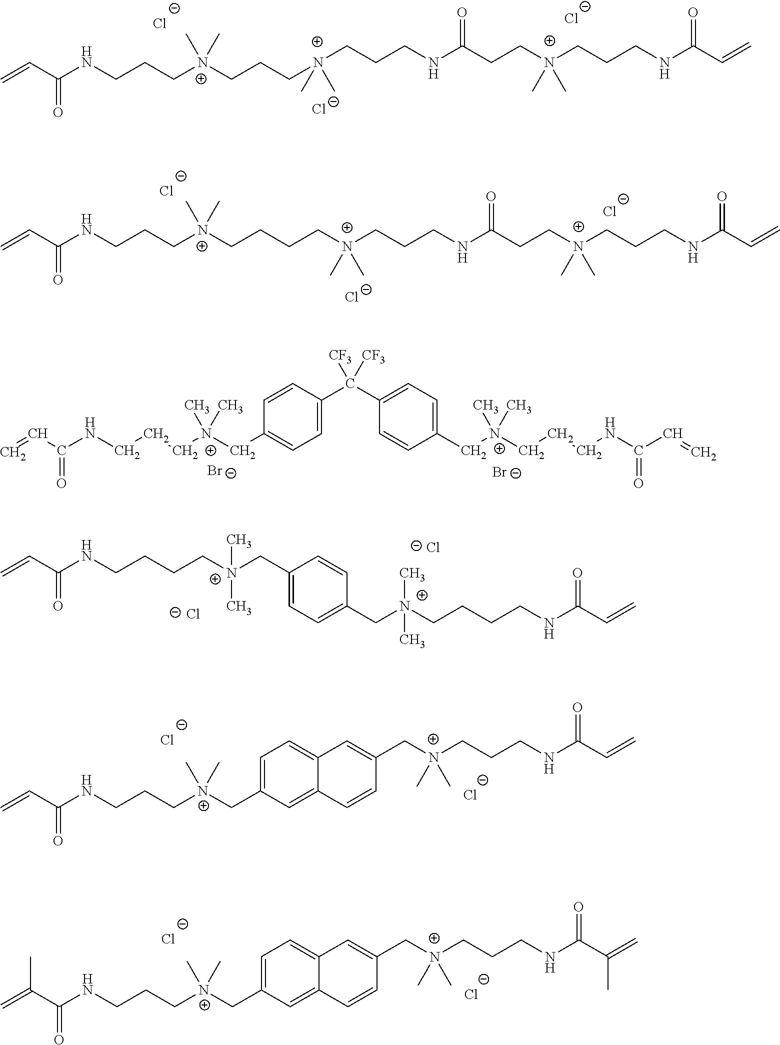

Synthesis methods can be found in e.g. US2015/0353721, US2016/0367980 and US2014/0378561.

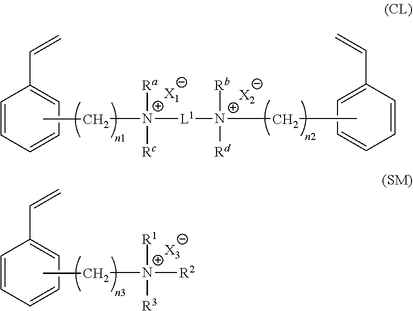

wherein in Formulas (CL) and (SM),
L¹ represents an alkylene group or an alkenylene group;
R^{a}, R^{b}, R^{c}, and R^{d} each independently represent a linear or branched alkyl group or an aryl group,
R^{a} and R^{b}, and/or R^{c} and R^{d} may form a ring by being bonded to each other;
R¹, R², and R³ each independently represent a linear or branched alkyl group or an aryl group, R¹ and R², or R¹, R² and R³ may form an aliphatic heterocycle by being bonded to each other;
n1, n2 and n3 each independently represent an integer of 1 to 10; and
X₁⁻, X₂⁻ and X₃⁻ each independently represent an organic or inorganic anion.
Examples of formula (CL) and (SM) include:

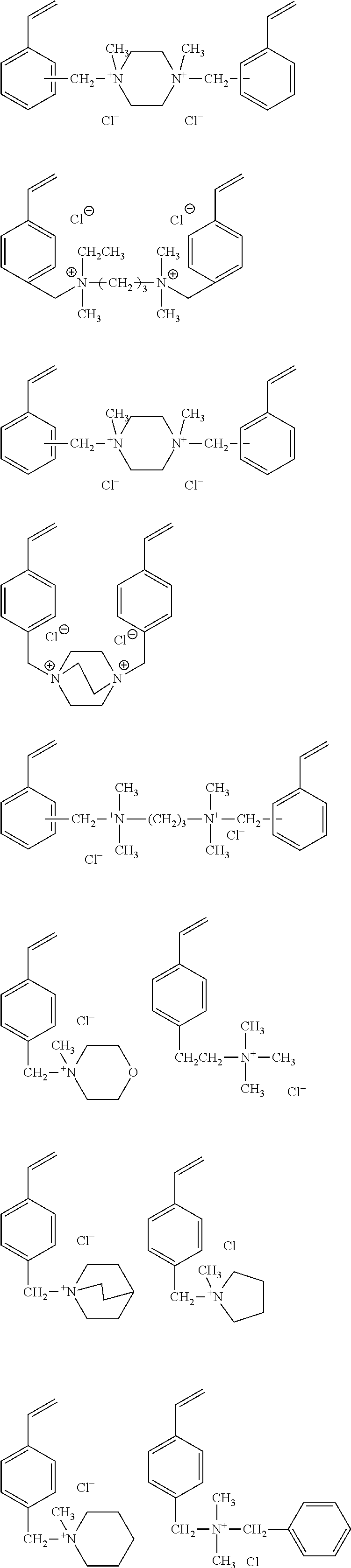

Synthesis methods can be found in EP3184558 and US2016/0001238.

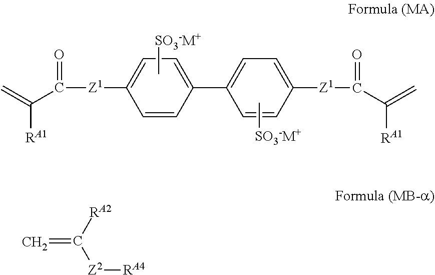

wherein in formula (MA) and (MB-α),
R^{A1} represents a hydrogen atom or an alkyl group;
Z¹ represents —O— or —NRa—, wherein Ra represents a hydrogen atom or an alkyl group;
M⁺ represents an organic or inorganic cation, preferably a hydrogen ion or an alkali metal ion;
R^{A2} represents a hydrogen atom or an alkyl group,
R^{A4} represents an organic group comprising a sulphonic acid group and having no ethylenically unsaturated group; and
Z² represents —NRa—, wherein Ra represents a hydrogen atom or an alkyl group preferably a hydrogen atom.
Examples of formula (MA) and (MB-α) include:

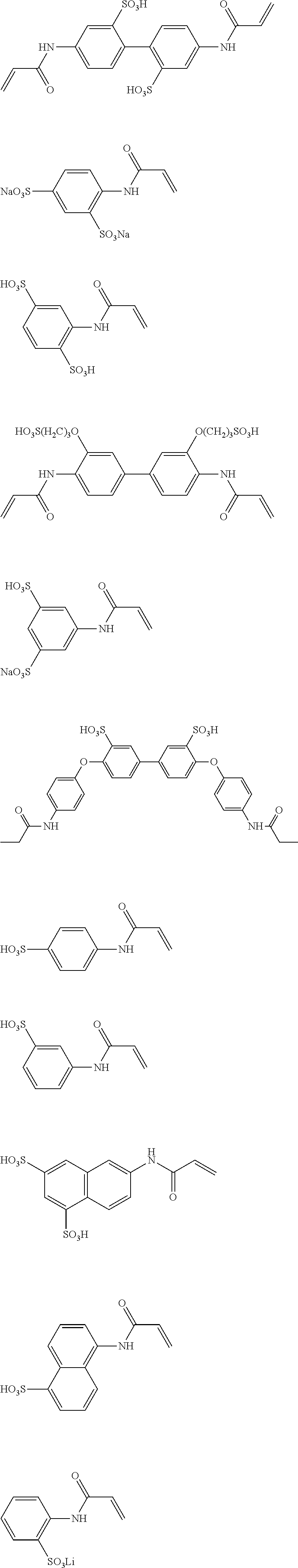

Synthesis methods can be found in e.g. US2015/0353696.

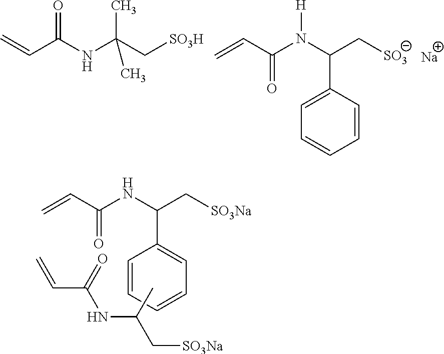

Synthesis methods can be found in e.g. US2016/0369017.

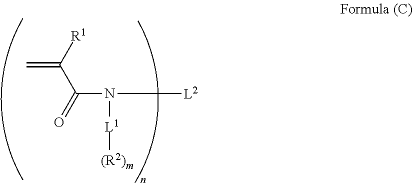

wherein in Formula (C),
L¹ represents an alkylene group;
n represents an integer of 1 to 3, preferably 1 or 2;
m represents an integer of 1 or 2;
L² represents an n-valent linking group;
R¹ represents a hydrogen atom or an alkyl group;
R² represents —SO₃⁻M⁺ or —SO₃R³⁻; in case of plural R²'s, each R² independently represents —SO₃M⁺ or —SO₃R³⁻;
M⁺ represents a hydrogen ion, an inorganic ion, or an organic ion; and
R³ represents an alkyl group or an aryl group.
Examples of formula (C) include:

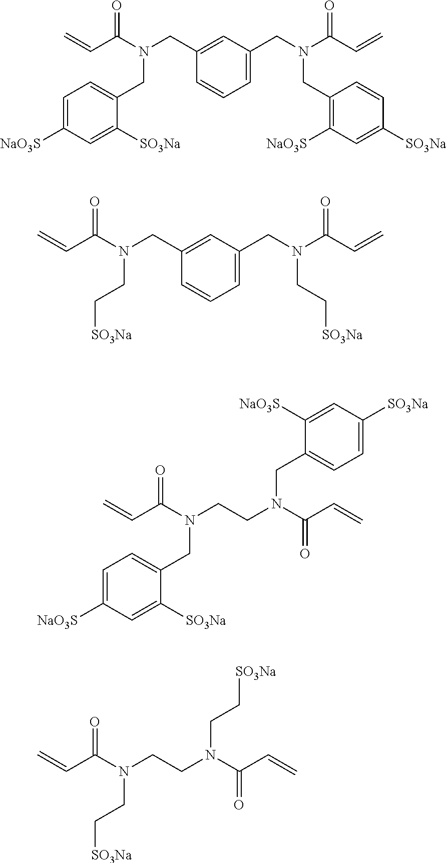

Synthesis methods can be found in EP3187516.

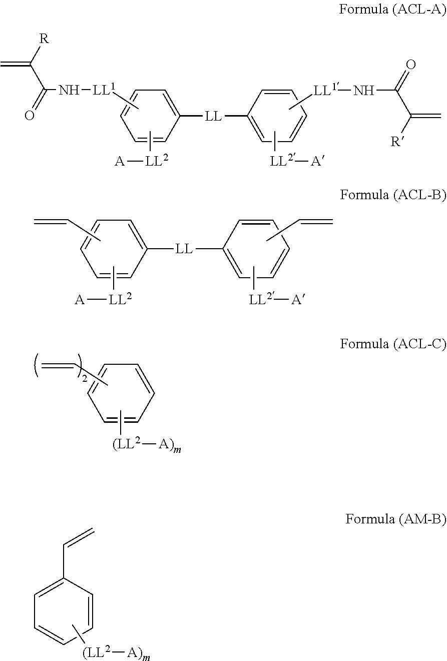

wherein in Formulas (ACL-A), (ACL-B), (ACL-C) and (AM-B),
each of R and R′ independently represents a hydrogen atom or an alkyl group;
LL represents a single bond or a bivalent linking group;
each of LL¹, LL¹′, LL², and LL²′ independently represents a single bond or a bivalent linking group; and each of A and A′ independently represents a sulfo group in free acid or salt form; and
m represents 1 or 2.
Examples of formula (ACL-A), (ACL-B), (ACL-C) and (AM-B) include:

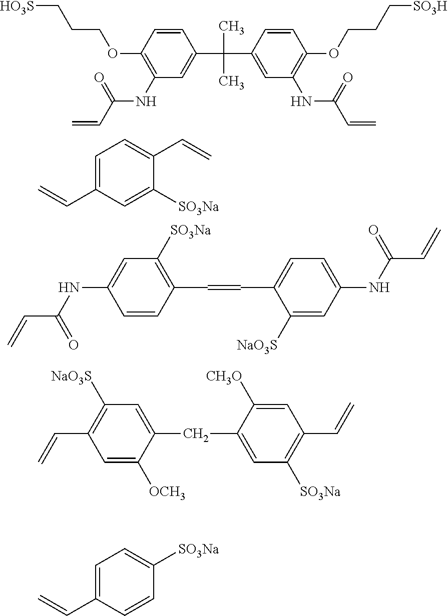

Synthesis methods can be found in US2016/0362526.
Other examples include:

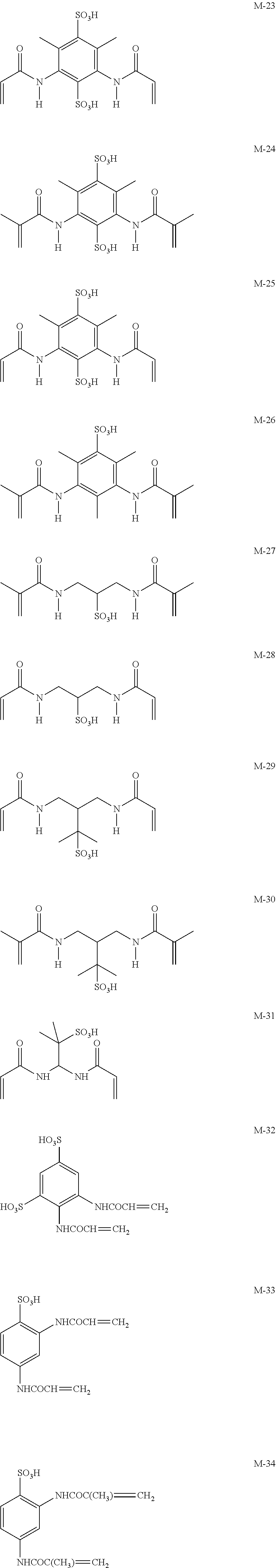

Preferably the curable composition comprises 20 to 95 wt %, more preferably 30 to 90 wt %, especially 35 to 85 wt %, of component (a).

Preferably the dye is as described above, e.g. a coloured photoinitiator, especially a Norrish Type II photoinitiator.

It is desirable for the composition used to make the AEMs or CEMs to be in the form of a solution in which all components have good solubility. Thus, where the composition comprises a polar solvent (e.g. water), component (b) preferably comprises one or more charged groups as these enhance the solubility in polar solvents such as water. Suitable charged groups include sulfo and carboxyl groups in free acid or salt form and quaternary ammonium groups.

Preferably component (b) is free from groups which have radical scavenging properties (e.g. nitro groups and thiol groups) as such groups may slow or inhibit curing.

Preferably component (b) does not contain two or more hydroxyl groups attached to atoms which form a part of the conjugated system

Preferably component (b) has at least two groups selected from chloro, bromo, iodo, primary, secondary or tertiary amino, alkyl, carbonyl, ether, thioether, carboxyl, sulfo and quaternary ammonium groups and is free from nitro, thiol and multiple hydroxyl groups.

Preferably the curable composition comprises 0.002 to 4 wt %, more preferably 0.005 to 2 wt %, especially 0.005 to 0.9 wt %, more especially 0.01 to 0.4 wt % of dye (component (b)).

Preferably the molar ratio of the dye and the co-initiator present in the curable composition (i.e. the ratio of component (b) to (c)) is larger than 1:1, more preferably larger than 1:2, especially larger than 1:5, more especially larger than 1:10.

Preferably the co-initiator (i.e. component (c)) comprises a tertiary amine, an acrylated amine, an onium salt (e.g. a salt of a iodonium, sulfonium, phosphonium or diazonium ion), a triazine derivative, an organohalogen compound, an ether group, a ketone, a thiol, a borate salt, a sulfide (e.g. thioether), a pyridinium salt, a ferrocenium salt, or two or more thereof.

Preferred co-initiators include triethylamine, triethanolamine, methyl diethanol amine, dimethylethanolamine, ethylenediamine-tetra(2-propanol), 1,4-dimethyl piperazine, n-phenyldiethanolamine, 4-(dimethylamino)benzaldehyde, 7-diethylamino-4-methylcoumarin, 2-(diethylamino)ethyl methacrylate, carbon tetrabromide, diphenyliodonium chloride, 2-ethylhexyl-4-dimethylaminobenzoate, 4-(dimethylamino)benzonitrile, ethyl-4-dimethylaminobenzoate, dimethylaminopropylacrylamide, dimethylaminoethyl methacrylate, diphenyliodonium nitrate, N-phenylglycine, 2,4,6-tris(trichloromethyl)-1,3,5-triazine, 2-(4-methoxyphenyl)-4,6-bis(trichloromethyl)-1,3,5-triazine, hexaethylmelamine, hexamethylenetetramine, piperonyl alcohol, N,N-dimethyl-p-toluidine, L-arginine, and mixtures comprising two or more thereof.

Although component (c) may contribute to dissolving the components of the composition, e.g. triethanolamine, for the purpose of this specification component (c) is not regarded as a solvent.

Preferably the curable composition comprises 0.01 to 40 wt %, more preferably 0.05 to 20 wt %, even more preferably 0.1 to 5 wt %, of co-initiator (component (c)).

Although generally not preferable, the curable composition may comprise a non-ionic monomer i.e. a monomer which is free from anionic and cationic groups, typically in low amounts for a specific purpose. Examples of component (d) include non-ionic monomers, e.g. hydroxyethylmethacrylate and methyl methacrylate, and non-ionic crosslinkers, e.g. as poly(ethylene glycol) diacrylate, bisphenol-A epoxy acrylate, bisphenol A ethoxylate diacrylate, tricyclodecane dimethanol diacrylate, neopentyl glycol ethoxylate diacrylate, propanediol ethoxylate diacrylate, butanediol ethoxylate diacrylate, hexanediol diacrylate, hexanediol ethoxylate diacrylate, poly(ethylene glycol-co-propylene glycol) diacrylate, poly(ethylene glycol)-block-poly(propylene glycol)-block-poly(ethylene glycol) diacrylate, isophorone diacrylamide, divinylbenzene, N,N′-(1,2-dihydroxyethylene)bis-acrylamide, N,N-methylene-bis-acrylamide, N,N′-ethylenebis(acrylamide), bis(aminopropyl)methylamine diacrylamide, tricyclodecane dimethanol diacrylate, 1,4-diacryoyl piperazine, 1,4-bis(acryloyl)homopiperazine, glycerol ethoxylate triacrylate, trimethylolpropane ethoxylate triacrylate, trimethylolpropane ethoxylate triacrylate, pentaerythrytol ethoxylate tetraacrylate, ditrimethylolpropane ethoxylate tetraacrylate, dipentaerythrytol ethoxylate hexaacrylate, 1,3,5-triacryloylhexahydro-1,3,5-triazine, 2,4,6-triallyloxy-1,3,5-triazine, and combinations comprising two or more thereof.

Preferably the composition comprises 0 to 50 wt % of component (d), more preferably 0 to 30 wt %. In one embodiment the composition is free from curable monomers which are free from anionic and cationic groups.

Optionally the curable composition further comprises, e.g. as component (e), one or more solvents. The solvent may be any solvent which does not copolymerize with the other components or act as a co-initiator. In an embodiment the solvent preferably comprises water and optionally an organic solvent, especially where some or all of the organic solvent is water-miscible. The water is useful for dissolving the curable monomer and the organic solvent is useful for dissolving other organic components of the curable composition. The solvent is useful for reducing the viscosity and/or surface tension of the curable composition.

Preferably, in some embodiments, the curable composition comprises 0 to 60 wt %, more preferably 4 to 50 wt %, most preferably 10 to 45 wt % of solvent (e.g. as component (e)).

In one embodiment component (e) comprises at least 50 wt % water, more preferably at least 70 wt % water, relative to the total weight of component (e). In one embodiment component (e) comprises less than 30 wt % of organic solvent and any remaining solvent is water. In another embodiment the composition is free from organic solvents, providing environmental advantages due to the complete absence of (volatile) organic solvents. In a specific embodiment water is used as solvent, e.g. water having a pH below 7.

In another embodiment component (e) comprises one or more organic solvents to dissolve the components of the composition and is free from water. This is especially useful when components (a), (b), (c) and (d) (when present) have a low or no solubility in water.

Preferred organic solvents which may be used as or in component (e) include C₁₋₄ alcohols (e.g. mono ols such as methanol, ethanol and propan-2-ol); diols (e.g. ethylene glycol and propylene glycol); triols (e.g. glycerol)); carbonates (e.g. ethylene carbonate, propylene carbonate, dimethyl carbonate, diethyl carbonate, di-t-butyl dicarbonate and glycerin carbonate); dimethyl formamide; dimethylsulfoxide, acetone; N-methyl-2-pyrrolidinone; and mixtures comprising two or more of the foregoing.

The organic solvent is inert (i.e. not copolymerisable with component (a) or (d) (when present)).

Component (e) may comprise none, one or more than one organic solvent.

Preferably the CEMs and/or AEMs comprise a porous support. A porous support is useful for strengthening the membranes.

The pores of the porous support may be filled with a curable composition such as the preferred curable composition described above and then curable composition may be cured.

As examples of porous supports there may be mentioned woven and non-woven synthetic fabrics and extruded films. Examples include wetlaid and drylaid non-woven material, spunbond and meltblown fabrics and nanofiber webs made from, e.g. polyethylene, polypropylene, polyacrylonitrile, polyvinyl chloride, polyphenylenesulfide, polyester, polyamide, polyaryletherketones such as polyether ether ketone and copolymers thereof. Porous supports may also be porous membranes, e.g. polysulfone, polyethersulfone, polyphenylenesulfone, polyphenylenesulfide, polyimide, polyethermide, polyamide, polyamideimide, polyacrylonitrile, polycarbonate, polyacrylate, cellulose acetate, polypropylene, poly(4-methyl 1-pentene), polyinylidene fluoride, polytetrafluoroethylene, polyhexafluoropropylene and polychlorotrifluoroethylene membranes and derivatives thereof.

The porous support preferably has an average thickness of between 10 and 700 μm, more preferably between 20 and 500 μm.

Preferably the porous support has a porosity of 30 and 95%. The porosity of the support may be determined by a porometer, e.g. a Porolux™ 1000 from IB-FT GmbH, Germany.

The porous support, when present, is optionally a porous support which has been treated to modify its surface energy, e.g. to values above 45 mN/m, preferably above 55 mN/m. Suitable treatments include corona discharge treatment, plasma glow discharge treatment, flame treatment, ultraviolet light irradiation treatment, chemical treatment or the like, e.g. for the purpose of improving the wettability of and the adhesiveness of the polymer to the porous support.

Commercially available porous supports are available from a number of sources, e.g. from Freudenberg Filtration Technologies (Novatexx materials), Lydall Performance Materials, Celgard LLC, APorous Inc., SWM (Conwed Plastics, DelStar Technologies), Teijin, Hirose, Mitsubishi Paper Mills Ltd and Sefar AG.

Preferably the support is a polymeric support.

Aromatic porous supports include porous supports derived from one or more aromatic monomers, for example aromatic polyamide (aramid), (sulfonated) polyphenylenesulfone, poly(phenylene sulfide sulfone), aromatic polyesters (e.g. polyethyleneterephthalate (PET) or polybutyleneterephthalate (PBT)), aromatic polyether ether ketone, polyphenylenesulfide or a combination of two or more of the foregoing. Examples of commercially available aromatic porous supports include Teijin, Hirose, Mitsubishi Paper Mills Ltd and Sefar AG.

Preferably the AEMs and/or CEMs are in the form of a sheet e.g. comprising a porous support.

The AEMs and/or CEMs (collectively “Ion exchange membranes”) may be produced by polymerizing the curable composition using irradiation with, for example, electron beam (EB) radiation and/or visible light. Heat curing is a thermal polymerization process and is generally very slow. EB curing does not require initiators but instead requires expensive equipment. Light curing is a fast and efficient process that requires high intensity light and a photoinitiator.

The curable composition described above may be cured using visible light if desired, e.g. LED light. Curing with visible light has many advantages compared to UV light (lower energy consumption, no harmful UV irradiation, no or much less useless IR irradiation and thus less heating of the product, no formation of ozone in the irradiation zone, a longer lifetime of the irradiation source and a higher spectral match that could reach 100% when monochromatic light is used). Thus LED light may be much more efficient than use of UV light. An ideal illumination source from a large number of possible sources can be selected for each photoinitiator system in order to maximize the spectral match between the emission spectrum of the light source and the absorption spectrum of the photoinitiator.

The curable composition may be handled under yellow or red light conditions, depending on the chosen photoinitiator.

Advantageously, curing of the curable composition comprising dyes and using visible light to form the ion exchange membranes is inhibited less by the presence of oxygen than prior art processes which cure using Type I photoinitiators and UV light. Furthermore, one may use lower amounts of photoinitiator than prior art processes due to the higher efficiency of the photoinitiator system.

Suitable sources of light having a wavelength in the range from 400 to 800 nm include light emitting diodes (e.g. white (450 nm & broad peak at 550 nm that extends up to 750 nm), blue (450 nm), green (530 nm), yellow (590 nm), red (625 nm) or UV-V (405 or 420 nm)); gas discharge lamps (mercury (430 & 550 nm), gallium (400 & 410 nm), indium (410 & 450 nm), thallium (530 nm) or hydrogen (490 nm)); sulfur plasma lamps (broad peak in complete visible spectrum with maximum at 500 nm). Suitable light emitting diodes can be obtained from, for example, Cree, Osram, Hoenle and Chromasens. Gas discharge lamps can be obtained from, for example, Heraus, Hoenle and uv-technik meyer GmbH. Sulfur plasma lamps can be obtained from, for example, Plasma-international and PlasmaBright. Preferably the curing uses light from a light emitting diode (“LED”).

The energy output of the irradiation source used to cure the composition is preferably from 1 to 1000 W/cm, preferably from 2 to 500 W/cm but may be higher or lower as long as cure can be achieved. The exposure intensity is one of the parameters that can be used to control the extent of curing and thereby influences the final structure of the AEM or CEM. Preferably the exposure dose is at least 40 mJ/cm², more preferably between 40 and 1500 mJ/cm², most preferably between 70 and 900 mJ/cm², as measured with a Power Puck II radiometer from Uvitron. A typical example of a light source for curing is a 420 nm monochromatic LED with an output of 25 W/cm as supplied by Hoenle.

To reach the desired exposure dose at high coating speeds, more than one irradiation source may be used, so that the composition is irradiated more than once.

WO2017009602 (′602) describes the preparation of ion exchange membranes from simple aliphatic monomers using thermal and Type I photoinitiators.

When the monomers used to make ion exchange membranes are all aliphatic and/or simple aromatic monomers (e.g. as in ′602) a UV curing step for forming the ion exchange membrane generally is quite effective. However when one or more of the monomers used to make an ion exchange membrane absorb significantly in the UV region (e.g. up to 380 nm or even higher) the absorption of UV light by the monomers can significantly interfere with the curing process. In such cases very high doses of UV light and/or high concentrations of photoinitiators are required to achieve the formation of sufficient number of radicals to accomplish the desired polymerization rate. The use of a high concentration of photoinitiators is undesirable for a number of reasons. For example, it is more expensive to use a high concentration of photoinitiators than a low concentration of photoinitiators. Ion exchange membranes made from curing compositions containing a high concentration of photoinitiator(s) are often considered to be unsuitable for use in food and pharmaceutical applications due to potential toxicity fears and often require extra processing to reduce the chances of unacceptable levels of photoinitiator leaching-out from the membrane and into the food or pharmaceutical product. Furthermore, a high dose of UV light generates a lot of heat which requires cooling and increases the risk of burning the membrane or any support or carrier which is present during the curing process. Also high energy costs are involved.

The curable composition may further comprise additives, for example a surfactant, pH regulator, viscosity modifier, structure modifier, stabilizer, polymerization inhibitor or two or more of the foregoing.

A surfactant or combination of surfactants may be included in the composition as, for example, a wetting agent or to adjust surface tension. Commercially available surfactants may be utilized, including radiation-curable surfactants. Surfactants suitable for use in the composition include non-ionic surfactants, ionic surfactants, amphoteric surfactants and combinations thereof.

Preferred surfactants are as described in WO 2007/018425, page 20, line 15 to page 22, line 6, which are incorporated herein by reference thereto. Fluorosurfactants are particularly preferred, especially Zonyl® FSN and Capstone® fluorosurfactants (produced by E. I. Du Pont). Also preferred are polysiloxane based surfactants, especially Surfynol™ from Air Products, Xiameter™ surfactants from DowCorning, TegoPren™ and TegoGlide™ surfactants from Evonik, Siltech™ and Silsurf™ surfactants from Siltech, and Maxx™ organosilicone surfactant from Sumitomo Chemical.

Preferably the composition comprises a polymerization inhibitor (e.g. in an amount of below 2 wt %). This is useful to prevent premature curing of the composition during, for example, storage. Suitable polymerization inhibitors include hydroquinone, hydroquinone mono methyl ether, 2,6-di-t-butyl-4-methylphenol, 4-t-butyl-catechol, phenothiazine, 4-oxo-2,2,6,6-tetramethyl-1-piperidinyloxy, free radical (4-oxo-TEMPO), 4-hydroxy-2,2,6,6-tetramethyl-1-piperidinyloxy, free radical (4-hydroxy-TEMPO), 2,6-dinitro-sec-butylphenol, tris(N-nitroso-N-phenylhydroxylamine) aluminum salt, Omnistab™ IN 510, and mixtures comprising two or more thereof.

Thus in a preferred aspect of the present invention the composition used to prepare the AEMs and/or CEMs comprises:

(a) from 20 to 95 wt % of component (a);
(b) from 0.002 to 4 wt % of component (b), component (b) preferably being Norrish Type II photoinitiator, preferably having an absorption maximum at a wavelength longer than 400 nm, when measured at a temperature of 23° C. in one or more of the following solvents: water, ethanol and toluene;
(c) from 0.01 to 40 wt % of component (c); and
(d) from 0 to 50 wt % of component (d).

In an embodiment of this preferred aspect of the present invention the composition further comprises from 0 to 60 wt % of component (e), solvent.

Preferably the AEMs and/or CEMs have a thickness, including the porous support (when present), of less than 250 μm, more preferably from 5 to 200 μm, most preferably from 10 to 150 μm, e.g. about 20, about 50, about 75 or about 100 μm.

Preferably the AEMs and/or CEMs have an ion exchange capacity of at least 0.1 meq/g, more preferably of at least 0.3 meq/g, especially more than 0.6 meq/g, more especially more than 1.0 meq/g, based on the total dry weight of the membrane (including the porous support when present). Ion exchange capacity may be measured by titration as described by Dlugolecki et al, J. of Membrane Science, 319 (2008) on page 217.

Preferably the AEMs and/or CEMs exhibit a swelling in water of less than 100%, more preferably less than 75%, most preferably less than 60%. The degree of swelling can be controlled by the amount of crosslinking agents, the amount of non-curable compounds and by selecting appropriate parameters in the curing step and further by the properties of the porous support (when present). Electrical resistance, permselectivity and swelling degree in water (aka water uptake) may be measured by the methods described by Dlugolecki et al, J. of Membrane Science, 319 (2008) on pages 217-218.

The AEMs and/or CEMs preferably have a low water permeability so that (hydrated) ions may pass through the membrane and (free) water molecules do not easily pass through the membrane. Preferably the water permeability of the AEMs and/or CEMs is lower than 1.10⁻⁹ m³/m²·s·kPa, more preferably lower than 1.10⁻¹⁰ m³/m²·s·kPa, most preferably lower than 5.10⁻¹¹ m³/m²·s·kPa, especially lower than 3.10⁻¹¹ m³/m²·s·kPa.

Preferably the AEMs and/or CEMs have a permselectivity for small cations (e.g. Na⁺) or anions (e.g. Cl⁻) above 90%, more preferably above 95%.

Preferably the AEMs and/or CEMs have an electrical resistance less than 15 ohm·cm², more preferably less than 10 ohm·cm², most preferably less than 8 ohm·cm². For certain applications a high electrical resistance may be acceptable especially when the permselectivity is very high, e.g. higher than 95%, and the water permeation very low, for example for processes that operate with low conductive streams such as systems used for producing ultrapure water and/or drinking water.

Preferably the AEMs are free from catalysts.

Preferably the CEMs are free from catalysts.

Preferably the AEMs are free from anionic groups.

Preferably the CEMs are free from cationic groups.

Preferably the stack is free from bipolar membranes.

The AEMs and/or CEMs may be prepared by a process comprising curing the compositions defined above.

The process may contain further steps if desired, for example the steps of applying the composition to a porous support prior to curing, washing and/or drying the cured composition (i.e. the polymer).

Optionally the process comprises the further step of washing out unreacted composition from the AEMs and/or CEMs.

While in an embodiment it is possible to prepare the AEMs and/or CEMs on a batch basis using a stationary support, it is much preferred to prepare a AEMs and/or CEMs on a continuous basis using a moving support (especially a moving porous support). The porous support may be in the form of a roll which is unwound continuously, or in the form of a hollow fibre, or the porous support may rest on a carrier, e.g. a continuously driven belt (or a combination of these methods). Using such techniques the composition can be applied to a porous support on a continuous basis or it can be applied to a porous support on a large batch basis.

The curable composition may be applied to a porous support by any suitable method, for example by curtain coating, blade coating, air-knife coating, knife-over-roll coating, slide coating, nip roll coating, forward roll coating, reverse roll coating, micro-roll coating, dip coating, foulard coating, kiss coating, rod bar coating or spray coating.

The curable composition typically forms a continuous film layer on the porous support or the carrier or the porous support may be impregnated with the composition. The coating of multiple layers can be done simultaneously or consecutively. When coating multiple layers, the curable compositions may be the same or different.

Thus the process step of applying the composition to a porous support may be performed more than once, either with or without curing being performed between each application of the composition. When the composition is applied to both sides of a porous support the resultant impregnated support may be symmetrical or asymmetrical, preferably symmetrical.

Thus in a preferred process for making the ion exchange membranes, the composition is applied continuously to a moving support (preferably a porous support), preferably by means of a manufacturing unit comprising one or more composition application station(s), one or more irradiation source(s) for curing the composition, an AEM or CEM collecting station and a means for moving the porous support from the composition application station(s) to the irradiation source(s) and to the AEM or CEM collecting station.

The composition application station(s) may be located at an upstream position relative to the irradiation source(s) and the irradiation source(s) is/are located at an upstream position relative to the AEM or CEM collecting station.

In order to produce a sufficiently flowable composition for application by a high speed coating machine, it is preferred that the composition has a viscosity below 5000 mPa·s when measured at 23° C., more preferably from 1 to 1500 mPa·s when measured at 23° C. Most preferably the viscosity of the composition is from 2 to 500 mPa·s when measured at 23° C.

With suitable coating techniques, the composition may be applied to a moving porous support at a speed of over 1 m/min, e.g. 5 m/min, preferably over 10 m/min, more preferably over 15 m/min, e.g. more than 20 m/min, or even higher speeds, such as 30 m/min, or up to 40 m/min can be reached.

During curing components (a) and (d) (when present) typically polymerise to form the polymer. Preferably the curing occurs sufficiently rapidly to form a polymer within 30 seconds. If desired further curing may be applied subsequently to finish off, although generally this is not necessary.

Preferably curing of the composition begins within 3 minutes, more preferably within 60 seconds, after the composition has been applied to a support.

Preferably the curing is achieved by irradiating the composition for less than 30 seconds, more preferably less than 10 seconds, especially less than 3 seconds, more especially less than 2 seconds. In a continuous process the irradiation occurs continuously and the speed at which the composition moves through the beam of irradiation is mainly what determines the time period of curing. The exposure time is determined by the irradiation time by the concentrated beam; stray ‘light’ generally is too weak to have a significant effect. Preferably the curing uses white, blue or green light. Suitable wavelengths are longer than 400 nm, provided the wavelength of light matches with the absorbing wavelength of component (b).

According to a second aspect of the present invention there is provided a process for preparing a stack of ion exchange membranes comprising the steps:

(i) providing a plurality of AEMs and CEMs wherein the colour properties of the AEMs is visibly different to the colour properties of the CEMs; and
(ii) assembling the stack such that the AEMs and the CEMs are in alternating order.

In the process according to the second aspect of the present invention one may use the visible difference in colour properties to ensure that the AEMs and the CEMs are in alternating order. For example, the colour properties of the AEMs and CEMs may be evaluated using the naked eye or using an optical sensor and the results of that evaluation may be used to assemble the stack such that the AEMs and the CEMs are in alternating order.

When the colour properties of the AEMs and CEMs are evaluated using an optical sensor, the assembly of the stack may be fully automated (e.g. operated under the control of a computer program) and in this way provide a very fast and efficient stack manufacturing process.

The stack may be assembled such that the AEMs and the CEMs are in alternating order by a process comprising gluing the edges of the AEMs and the CEMs together, typically to provide alternating ion diluting compartments and an ion concentrating compartments, e.g. comprising a wall made from a negatively-charged cation exchange membrane (a cation exchange membrane or “CEM”) and a wall made from a positively-charged anion exchange membrane (an anion exchange membrane or “AEM”). Alternatively the stack may be assembled by placing the AEMs and CEMs on top of each other with a spacer between each membrane.

Optionally the process further comprises the step of verifying that the AEMs and CEMs are in alternating order using the visibly different colour properties of the AEMs and CEMs.

According to a third aspect of the present invention there is provided an electrodialysis or reverse electrodialysis unit, an electrodeionization module, a flow through capacitor, a diffusion dialysis apparatus, a membrane distillation module or an electrolyser comprising one or more stack of ion exchange membranes according to the first aspect of the present invention. The electrodeionization module is preferably a continuous electrodeionization module.

Preferably the electrodialysis or reverse electrodialysis unit or the electrodeionization module or the flow through capacitor comprises at least one anode, at least one cathode and two or more membranes according to the second aspect of the present invention.

In a preferred embodiment the unit comprises at least 10, more preferably at least 25, e.g. 36, 64, 200, 600 or up to 1500, membrane pairs (one AEM and one CEM being a “membrane pair”), the number of membrane pairs being dependent on the application. The membrane pairs may for instance be used in a plate-and-frame or stacked-disk configuration or in a spiral-wound design.

According to a fourth aspect of the present invention there is provided use of the stack according to the first aspect of the present invention or the unit, module, apparatus or electrolyser according to the third aspect of the present invention for the treatment of an aqueous stream, for example for water softening, tartaric stabilization of wine, demineralization of whey, for purification of a liquid (e.g. water, a sugar syrup, fruit juice, organic solvents, mineral oils and a solution of metal ions), dehumidification, or for the generation of energy.

Although the stacks of the present invention are primarily intended for use in water purification (e.g. by electrodeionisation or electrodialysis, including continuous electrodeionisation (CEDI) and electrodialysis reversal (EDR)), they may also be used for other purposes, e.g. for reverse electrodialysis (RED).

Thus the invention provides a stack of ion exchange membrane comprising alternate CEMs and AEMs wherein the CEMs each have the same colour or depth of shade as each other and a different colour and/or depth of shade than the AEMs. When also monovalent selective membranes are used they can be given a different colour than the standard membranes by selecting a different component (b) or a different amount of component (b).

The invention will now be illustrated with non-limiting Examples where all parts and percentages are by weight unless specified otherwise.

In the Examples the following properties were measured by the methods described below.

In the Examples the following properties were measured by the methods described below.

TABLE 1
Materials

| | Component | Abbrevia- |
|---|---|---|
| Component | type | tion |
| Sodium salt of 2-acryloylamido-2- | (a) | Na-AMPS |
| methylpropanesulfonic acid from | | |
| Sigma-Aldrich. | | |
| 3-Acrylamidopropyl-trimethyl- | (a) | DMAPAA-Q |
| ammonium chloride from Kohjin. | | |
| N,N-(1,4-phenylenebis(methyl- | (a) | CL-3 |
| ene))bis(3-acrylamido N,N-dimethyl- | | |
| propan-1-aminium) | | |
| bromide, a positively charged cross- | | |
| linking agent synthesized as described | | |
| in WO2013011273, page 25, lines 15-21. | | |
| Sodium salt of divinylbenzene sulfonate | (a) | Na-DVBS |
| from TOSOH | | |
| Triethanolamine (a co-initiatorfrom | (c) | TEOA |
| Sigma-Aldrich). | | |
| Diphenyliodonium chloride (a co-initiator | (c) | IO |
| from TCI Co.). | | |
| Darocur ™ 1173 (a Type I photoinitiator | NA (a | 1173 |
| from BASF (this is not a coloured photo- | photoinitiator | |
| initiator). | which is not | |
| | a dye) | |
| Fluorescein disodium salt from Sigma- | (b) | FL |
| Aldrich | | |
| Erythrosin B from Sigma-Aldrich | (b) | EB |
| Methylene Blue from Sigma-Aldrich | (b) | MB |
| Resazurin sodium salt from Sigma-Aldrich | (b) | RZ |
| Quinaldine Red from Sigma-Aldrich | (b) | QR |
| Viledon ® Novatexx 2223-10 (a non- | Porous | 2223-10 |
| woven, polypropylene/polyethylene | support | |
| porous support from Freudenberg | | |
| Filtration Technologies) | | |

TABLE 2
Properties of several coloured photoinitiators in the stated solvents

| | | | Molar | |
|---|---|---|---|---|
| | | | attenuation | Number of |
| Coloured | Abs. max | | coefficient | conjugated π |
| Photoinitiator | (nm) | Solvent | (M⁻¹cm⁻¹) | electrons |
| 1173 | 243 | ethanol | Not applicable | 6 |
| FL | 480 | water | 92300 | 20 |
| EB | 530 | ethanol | 84500 | 20 |
| MB | 654 | ethanol | 40700 | 14 |
| RZ | 600 | water | 20600 | 14 |
| QR | 528 | Water | 108000 | 18 |

### Step (a) Preparation of Compositions for Makin the AEMs and CEMs

The compositions used to make the AEMs contained the ingredients indicated in Table 3 below wherein the photoinitiator is 1173, EL, EB, MB, RZ or QR:

TABLE 3
AEM Compositions used to make AEMs

| Component type | Component Name (wt %) |
|---|---|
| (a) | DMAPAA-Q (15 wt %) |
| (a) | CL-3 (45 wt %) |
| (b) | Dye/Photoinitiator (0.5 wt %) |
| (c) | TEOA (1 wt %) |
| (c) | IO (0.25 wt %) |
| (e) | Water (38.25 wt %) |

The compositions used to make the CEMs contained the ingredients indicated in Table 4 below wherein the photoinitiator is 1173, EL, EB, MB, RZ or QR:

TABLE 4
CEM Compositions used to make CEMs

| Component type | Component Name (wt %) |
|---|---|
| (a) | Na-AMPS (35 wt %) |
| (a) | Na-DVBS (20 wt %) |
| (b) | Dye/Photoinitiator (0.5 wt %) |
| (c) | TEOA (1 wt %) |
| (c) | IO (0.25 wt %) |
| (e) | Water (43.25 wt %) |

### Step (b)- Preparation of the AEMs and CEMs

The AEMs and CEMs were prepared using the following general method: the relevant composition from Step (a) above was coated as a 100 μm layer onto a PET sheet using a 100 μm Meyer bar. A porous support (2223-10) was placed in the layer of the composition and any excess composition was scraped-off. The composition present in the porous support was then cured by placing it on a conveyer belt set at 5 m/min, equipped with a Heraeus F450 microwave-powered UV-curing system with a medium-pressure mercury bulb (240 W/cm, 100%) to give the AEM or CEM, depending on the composition used.

### Colour Properties of the AEMs and CEMs

The colour properties of the AEMs and CEMs arising from step (b) were measured according to CIEDE2000 using a Konica Minolta CM-3600a spectrophotometer, using an 8 mm MAV measurement area and a white calibration plate (Minolta CM-A139) of the Optical Tool sample holder. The results were as follows:

TABLE 5
Colour data of AEM1 toAEM6
(EL, EB, MB, RZ or QR identify the coloured
photoinitiator used and 1173 is not a
coloured photoinitiator)

| | AEM1 | AEM2 | AEM3 | AEM4 | AEM5 | AEM6 |
|---|---|---|---|---|---|---|
| Photoinitiator | 1173 | FL | EB | MB | RZ | QR |
| L′ | 86 | 86 | 60 | 74 | 38 | 35 |
| C′ | 3 | 97 | 70 | 11 | 15 | 46 |
| h′ | 110 | 66 | 6 | 234 | 335 | 355 |

TABLE 6
Colour data of CEM1 to CEM6 (EL, EB,
MB, RZ or QR identify the coloured photoinitiator
used and 1173 is not a coloured photoinitiator)

| | CEM1 | CEM2 | CEM3 | CEM4 | CEM5 | CEM6 |
|---|---|---|---|---|---|---|
| Photoinitiator | 1173 | FL | EB | MB | RZ | QR |
| L′ | 82 | 72 | 30 | 35 | 68 | 38 |
| C′ | 2 | 62 | 42 | 16 | 21 | 18 |
| h′ | 138 | 78 | 8 | 255 | 332 | 358 |

TABLE 7
Colour difference data (ΔE₀₀) with AEMs shown
horizontally and CEMs shown vertically

| | AEM1 | AEM2 | AEM3 | AEM4 | AEM5 | AEM6 |
|---|---|---|---|---|---|---|
| ΔE₀₀ | 1173 | FL | EB | MB | RZ | QR |
| CEM1 | 3.4 | 80.9 | 74.7 | 13.9 | 47.1 | 66.9 |
| 1173 | | | | | | |
| CEM2 | 60.9 | 21.1 | 78.8 | 72.2 | 75.1 | 81.4 |
| FL | | | | | | |
| CEM3 | 69.6 | 93.1 | 41.1 | 66.8 | 31.6 | 11.8 |
| EB | | | | | | |
| CEM4 | 53.33 | 107.2 | 81.1 | 39.6 | 20.2 | 51.3 |
| MB | | | | | | |
| CEM5 | 28.9 | 91.0 | 54.5 | 25.7 | 30.6 | 43.2 |
| RZ | | | | | | |
| CEM6 | 50.8 | 90.9 | 56.7 | 44.3 | 7.2 | 28.2 |
| QR | | | | | | |

In Tables 5 to 7 the following abbreviations are used:
Photoinitiator means the photoinitiator used to make the AEM (from the composition described in Table 3 above) or the CEM (from the composition described in Table 4 above).
L′ means lightness according to CIEDE2000.
C′ means chroma according to CIEDE2000.
h′ means hue angle according to CIEDE2000.
AEM means anion exchange layer.
CEM means cation exchange layer.
ΔE₀₀ means the colour difference between the AEM and the CEM according to CIEDE2000.
EL, EB, MB, RZ and QR identify the coloured photoinitiator used and 1173 is not a coloured photoinitiator

1. A stack of ion exchange membranes comprising a plurality of anion exchange membranes (AEMs) and a plurality of cation exchange membranes (CEMs), wherein the colour properties of the AEMs are visibly different to the colour properties of the CEMs.

2. The stack according to claim 1 wherein one or both of the AEMs and CEMs comprises a dye such that the colour properties of the AEMs are visibly different to the colour properties of the CEMs to ensure that AEMs and CEMs are in the right order.

3. The stack according to claim 1 wherein the CEMs are obtained from curing a curable composition comprising:
(a) one or more curable monomers comprising at least one anionic group;
(b) a dye;
(c) optionally a co-initiator;
(d) optionally a curable monomer which is free from anionic and cationic groups; and
(e) optionally a solvent;
and/or the AEMs are obtained from curing a curable composition comprising:
(a) one or more curable monomers comprising at least one cationic group;
(b) a dye;
(c) optionally a co-initiator;
(d) optionally a curable monomer which is free from anionic and cationic groups; and
(e) optionally a solvent.

4. The stack according to claim 2 wherein the dye is a Norrish Type II photoinitiator.

5. The stack according to claim 2 wherein the dye is a Norrish Type II photoinitiator having an absorption maximum at a wavelength longer than 400 nm, when measured at a temperature of 23° C. in one or more of the following solvents: water, ethanol and toluene.

6. The stack according to claim 2 wherein the molar attenuation coefficient of the dye at the absorption maximum is at least 7,500 M⁻¹ cm⁻¹.

7. The stack according to claim 2 wherein the co-initiator (c) is present and is a chemical which can generate a free radical in reaction with component (b) when component (b) is in an electronic exited state.

8. The stack according to claim 2 wherein component (c) comprises a tertiary amine, an acrylated amine, an onium salt (e.g. a salt of an iodonium, sulfonium, phosphonium or diazonium ion), a triazine derivative, an organohalogen compound, an ether group, a ketone, a thiol, a borate salt, a sulfide, a pyridinium salt, a ferrocenium salt, or two or more thereof.

9. The stack according to claim 2 wherein the dye comprises a xanthene, flavin, curcumin, porphyrin, anthraquinone, phenoxazine, phenazine, acridine, phenothiazine, xanthone, thioxanthone, thioxanthene, acridine, acridone, flavone, coumarin, fluorenone, quinolone, naphtaquinone, quinolinone, arylmethane, azo, benzophenone, carotenoid, cyanine, phtalocyanine, dipyrrin, squarine, stilbene, styryl, triazine or anthocyanin derived photoinitiator, in each case having an absorption maximum at a wavelength longer than 400 nm, when measured in a solvent selected from water, ethanol and toluene at a temperature of 23° C.

10. The stack according to claim 1 wherein the visible difference in colour properties comprises a difference in ΔE₀₀, as expressed according to CIEDE2000, of at least 4.

11. The stack according to claim 1 wherein at least one of the AEMs and CEMs has a lightness, as expressed by L′ according to CIEDE2000, of less than 90 and at least 10.

12. (canceled)

13. The stack according to claim 1 wherein at least one of the AEMs and CEMs has a saturation, as expressed by chroma C′ according to CIEDE2000, of at least 5.

14. The stack according to claim 1 wherein at least one of the AEMs and CEMs has a hue, as expressed by hue h′ according to CIEDE2000, of less than 70° or at least 100°.

15. The stack according to claim 1 wherein the CEMs each have the same colour and/or depth of shade as each other and a different colour and/or depth of shade from the AEMs.

16. A process for preparing a stack of ion exchange membranes comprising the steps:
(i) providing a plurality of AEMs and a plurality of CEMs wherein the colour properties of the AEMs are visibly different to the colour properties of the CEMs; and
(ii) assembling the stack such that the AEMs and the CEMs are in alternating order using the visible difference in colour properties.

17. An electrodialysis or reverse electrodialysis unit, an electrodeionization module, a flow through capacitor, a diffusion dialysis apparatus, a membrane distillation module or an electrolyser comprising one or more stacks of ion exchange membranes according to claim 1.

18. A method for using the stack according to claim 1 for the treatment of an aqueous stream, for example for water softening, tartaric stabilization of wine, demineralization of whey, for purification of a liquid (e.g. water, a sugar syrup, fruit juice, organic solvents, mineral oils and a solution of metal ions), dehumidification, or for the generation of energy.

19. The stack according to claim 2 wherein the dye comprises a conjugated system having at least 10 delocalized electrons.

20. The stack according to claim 1 wherein the stack is free from perfluorinated polymers.

21. The process according to claim 16 wherein one or both of the AEMs and CEMs comprises a dye such that the colour properties of the AEMs are visibly different to the colour properties of the CEMs.
